(19) United States
(12) Patent Application Publication
(10) Pub. No.: US 2021/0219675 A1
(43) Pub. Date: Jul. 22, 2021

(54) ILLUMINATED JEWELRY CONTROLLED BY BLUETOOTH

(71) Applicant: Edwin Febles, Flushing, NY (US)

(72) Inventor: Edwin Febles, Flushing, NY (US)

(21) Appl. No.: 16/745,254

(22) Filed: Jan. 16, 2020

(51) Int. Cl. A44C 15/00; H04W 4/80; A44C 7/00

(52) U.S. Cl. CPC A44C 15/0015; A44C 7/00; H04W 4/80

(57) ABSTRACT

This disclosure generally relates to light-emitting jewelry systems with light emission controlled by a Bluetooth unit. The light-emission may be provided by LED electronics. The jewelry may be women's\men's earrings. The illumination of the jewelry may be of low, medium, or high intensity. In a preferred embodiment, the illumination may be of low intensity. The light-emitting jewelry system may further include a battery unit.

### BACKGROUND OF THE DISCLOSURE

### Field of the Invention

This disclosure is generally related to jewelry, and more specifically, jewelry that can be light-emitting controlled by, for example, a Bluetooth connection.

### Description of the Related Art

Currently, lighted jewelry has many drawbacks and deficiencies. For example, battery capacity is insufficient, battery designs are not adequate, and camouflaging the battery and electronics is problematic. These deficiencies and limitations have made it difficult to keep the cost down and the size of the device reasonable.

Furthermore, placing a product behind the ear has inherent problems. For example, avoiding making the product appear as a hearing device. Battery design is also an issue. The footprint of the battery should be small behind the ear. A jewelry product meeting all of the above limitations is, in fact, currently not available.

### SUMMARY OF THE INVENTION

This disclosure generally relates to light-emitting jewelry systems with light emission controlled by a Bluetooth unit. The light-emission may be provided by LED electronics. The jewelry may be women's\men's earrings. The illumination of the jewelry may be of low, medium, or high intensity. In a preferred embodiment, the illumination may be of low intensity. The light-emitting jewelry system may further include a battery unit.

Other features and aspects will be apparent from the following detailed description, the drawings, and the claims

### BRIEF DESCRIPTION OF THE DRAWINGS

FIG. 1 shows one embodiment of a Bluetooth unit and battery unit of the disclosure.

FIG. 2 shows an embodiment of a Bluetooth unit, battery unit, and illuminated earring of the invention.

FIG. 3 shows an embodiment of a Bluetooth unit, lighted or illuminated earring, wire and decoration of the present disclosure.

FIG. 4 shows another embodiment of the disclosure.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

This disclosure generally relates to light-emitting jewelry controlled by Bluetooth. The light-emission may be provided by LED electronics. The jewelry may be, more specifically, women's\men's earrings. The illumination of the jewelry may be of low, medium, or high intensity. In a preferred embodiment, the illumination may be of low intensity. In some cases, the illumination may be low enough that it may not be immediately noticeable by a casual observer at first glance. Low intensity illumination provides the benefits of conservation of energy while enhancing the beauty of the jewelry without making the illumination a focal point.

This disclosure, accordingly, in one embodiment, provides specially designed jewelry, including earrings, that utilize lighting as an enhancement, and a Bluetooth unit to control the lighting.

The disclosed jewelry lighting system may include a lighting unit. The lighting unit may include a light-emitting diode (LED). More specifically, for example, the lighting unit may include very small light-emitters. Specific examples would include Pico lights™ (e.g., 3V) and Nano light™ emitters. The lights in the lighting unit may be very small. They may be, for example, no larger than the tip of a ballpoint pen.

The jewelry light system may also include a Bluetooth control unit. With a Bluetooth control unit, a user may be able to control the light hue, intensity, and\or color. For example, this may be done to better match a user's attire.

The disclosed jewelry lighting system may also include batteries. The batteries may be, for example, rechargeable lithium ion batteries. The batteries may further include a charging case. In one embodiment, the battery case may be separated from the Bluetooth device which can reduce the size of both units behind the ear. In embodiments, the disclosed jewelry lighting system has a camouflaged Bluetooth unit. For example, with camouflaging the product may not appear as a hearing device to an observer.

In one specific example, the disclosed jewelry lighting system can be placed behind a user's ear with a wire going through the earlobe, through an earring hook, and into the jewelry.

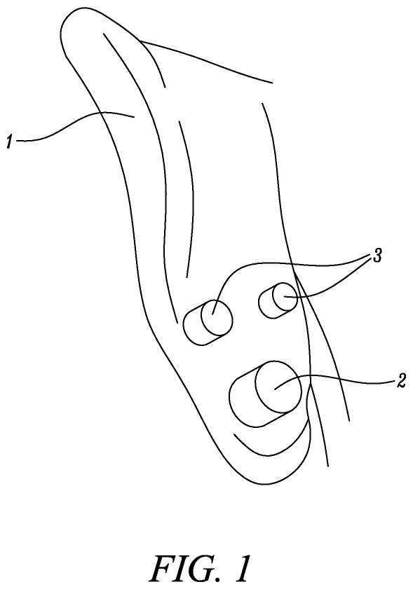

FIG. 1 shows one embodiment of a lighted jewelry system. In FIG. 1 a Bluetooth unit 2 is positioned at the bottom of a user's ear 1, e.g., at the bottom of the earlobe. Two smaller cylinders 3 are physically arranged parallel batteries. In other embodiments, the position of the Bluetooth unit may be reversed to be on top with a battery at the bottom. In this configuration, the battery may be larger than that shown in FIG. 1.

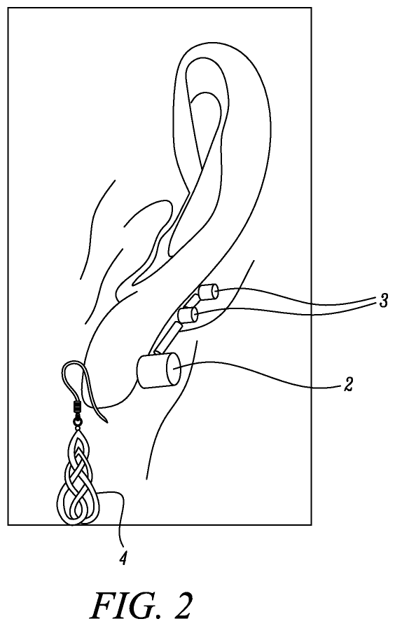

FIG. 2 shows another embodiment. In FIG. 2 Bluetooth unit 2 is shown with batteries 3 and illuminated earring 4.

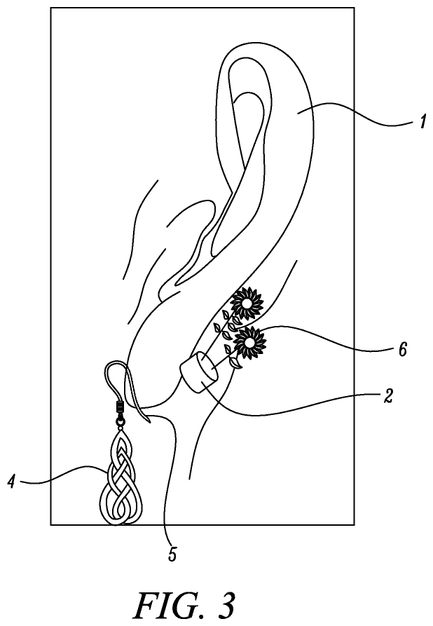

FIG. 3 shows another embodiment. FIG. 3 shows illuminated earring 4 with wire 5, Bluetooth unit 2, and decoration 6 for Bluetooth unit 2. Decoration 6 is provided to conceal or disguise the Bluetooth unit, batteries, and/or the wire from view.

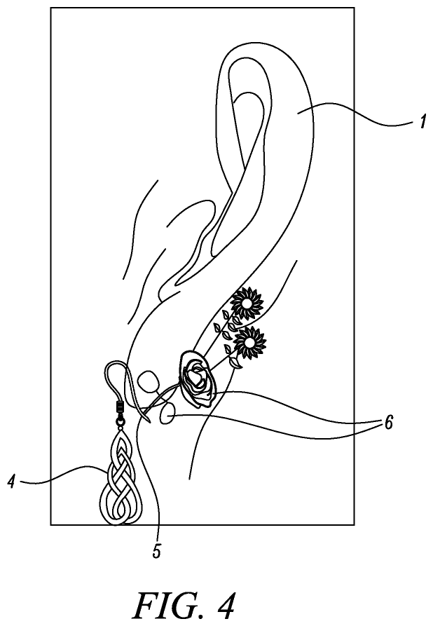

FIG. 4 shows another embodiment with illuminated or lighted earring 4, wire 5, and another decoration 6 disguising or masking the Bluetooth unit, batteries and wire from view by a third party.

While this disclosure includes specific examples, it will be apparent after an understanding of the disclosure of this application has been attained that various changes in form and details may be made in these examples without departing from the spirit and scope of the claims and their equivalents.

1. An illuminated jewelry system comprising:
A piece of jewelry:
a BLUETOOTH® unit;
a battery unit; and
wherein the Bluetooth unit controls a lighting unit in the piece of jewelry.

2. The illuminated jewelry system of claim 1, wherein the piece of jewelry is an earring.

3. The illuminated jewelry system of claim 1, wherein the lighting unit comprises a light emitting diode (LED).

4. The illuminated jewelry system of claim 1, wherein the lighting unit comprises a PICO LIGHT™ light emitters.

5. The illuminated jewelry system of claim 1, wherein the lighting unit comprises a NANOLIGHT™ light emitters.

6. The illuminated jewelry system of claim 1, wherein the battery unit comprises a rechargeable lithium-ion battery.

7. The illuminated jewelry system of claim 1, wherein the battery unit comprises two or more physically arranged parallel batteries.

8. The illuminated jewelry system of claim 1, wherein the battery unit comprises two physically arranged parallel batteries.

9. The illuminated jewelry system of claim 1, wherein the intensity of the illumination is not immediately noticeable to an observer without closer inspection.

10. The illuminated jewelry system of claim 1, wherein the BLUETOOTH® unit is adapted to be positioned behind a user's ear.

11. The illuminated jewelry system of claim 10, wherein a wire connects the BLUETOOTH ® unit and an earring.

12. The illuminated jewelry system of claim 11, wherein the wire is adapted to be positioned through a user's earlobe.

13. The illuminated jewelry system of claim 1, further comprising a decoration partially or completely covering the BLUETOOTH ® unit.

14. The illuminated jewelry system of claim 1, further comprising a decoration partially or completely covering the battery unit.
